(19) United States
(12) Patent Application Publication
(10) Pub. No.: US 2022/0364993 A1
(43) Pub. Date: Nov. 17, 2022

(54) INSPECTION SYSTEM FOR OPTICAL SURFACE INSPECTION OF A TEST SPECIMEN

(71) Applicant: Schaeffler Technologies AG & Co. KG, Herzogenaurach (DE)

(72) Inventors: Udo Fleischmann, Nürnberg (DE); Peter Braun, Schweinfurt (DE); Marcus Hess, Sennfeld (DE)

(73) Assignee: Schaeffler Technologies AG & Co. KG, Herzogenaurach (DE)

(21) Appl. No.: 17/774,217

(22) PCT Filed: Nov. 20, 2020
(86) PCT No.: PCT/DE2020/100981

§ 371 Date: May 4, 2022

(30) Foreign Application Priority Data
Dec. 2, 2019 (DE) 10 2019 132 585.4

(51) Int. Cl. G01N 21/64; G01N 21/94

(52) U.S. Cl. CPC G01N 21/6456; G01N 21/94; G01N 2021/646

(57) ABSTRACT

An inspection system for optical surface inspection of a test specimen having a fluorescent agent arranged on the test specimen includes an illumination system, an optical detection system, and a detection filer system. The illumination system is for illuminating the test specimen and the fluorescent agent with illuminating radiation, and includes one or more illuminating means. The optical detection system is for detecting fluorescent radiation emitted by the test specimen with the fluorescent agent. The detection filter system is set up to filter illumination radiation of the illumination system in the inspection system in such a way that the optical detection system only detects fluorescence radiation from the fluorescence agent.

### CROSS-REFERENCE TO RELATED APPLICATIONS

This application is the United States National Phase of PCT Appin. No. PCT/DE2020/100981 filed Nov. 20, 2020, which claims priority to German Application Nos. DE102019132585.4 filed Dec. 2, 2019, the entire disclosures of which are incorporated by reference herein.

### TECHNICAL FIELD

The present disclosure relates to an inspection system for optical surface inspection of a test specimen, in particular a ceramic test specimen, having a fluorescent agent arranged on the test specimen.

### BACKGROUND

Generally known surface examinations of test specimens for imperfections are usually carried out manually. This means that, in principle, a human tester is required to personally carry out the corresponding surface inspection by means of a visual inspection.

As a method for determining defects in ceramic bodies, the following methods have heretofore been known: For example, a liquid with penetrating power containing a coloring agent is allowed to penetrate into fine cavities provided in a ceramic body, and then excess liquid adhering to the surface of the ceramic body is washed off. As a result, no colorant adheres to a defect-free part of the ceramic body, while the colorant remains on any defective part. Thus, such a failure can be deteii fined by confirming the presence or absence of the coloring agent with the naked eye. Furthermore, a fluorescent dye can be used instead of the colorant, in which case the fluorescent dye is allowed to penetrate a ceramic body and excess dye is washed off with water. Then, the ceramic body is irradiated with ultraviolet rays in a darkroom so that any defects in the ceramic body can be detected by utilizing the emission of light from the fluorescent dye that has penetrated into the defect. In both of the methods mentioned above, the presence or absence of an error has been judged with the human eye.

However, since the above-mentioned methods of determining defects are based on judgment with the human eye, the ability to determine defects depends on the skill or experience of the quality controller, or a small defect may be overlooked. Furthermore, since the quality control is dependent on the human eye, the automation of successive steps is hindered, resulting in manufacturing processes with low productivity. The superimposition of wavelengths of different radiation represents a major problem of quality control, since the ultraviolet rays and the emission of light from the fluorescent dye that has penetrated the defect lead to incorrect detections during automation attempts. So far, this problem can only be resolved through the skill or experience of the quality inspectors.

A solution to decouple the skill or experience of quality controllers from the surface inspection of a test specimen, in particular a ceramic test specimen, is proposed in the laid-open specification DE4208947 A1. This discloses a method for determining defects in ceramic bodies, wherein a liquid with high electrical conductivity and good penetrating power is allowed to penetrate into a possible defect including a fine cavity to form an electrically conductive layer in the defect. Also proposed is a method using a liquid with high penetrating power capable of forming an electrically conductive layer by heat treatment or chemical treatment, penetrating such a defect, and thereafter fixating an electrically conductive layer in the defect through the heat treatment or chemical treatment, and then the presence or absence of the defect is determined by measuring the electrical conductivity between two given points short-circuited by the electrically conductive layer.

Although the aforementioned method enables a solution that does not take into account the skill or experience of a quality controller for surface inspection of a test specimen, in particular a ceramic test specimen, this method is associated with a high level of effort due to the inspection of electrical conductivity. Furthermore, no parallel redundant or sole visual inspection can be carried out.

### SUMMARY

The present disclosure provides an inspection system that can be automated and a corresponding method for optical surface inspection of a test specimen, in particular a ceramic test specimen, with a fluorescent agent arranged on the test specimen. In particular, the fluorescent agent is arranged in imperfections.

The present disclosure provides an inspection system for optical surface inspection of a test specimen having a fluorescent agent arranged on the test specimen, wherein the fluorescent agent is arranged in particular in imperfections, including

an illumination system for illuminating the test specimen and the fluorescent means with illuminating radiation, with one or more illuminating means;

an optical detection system for detecting fluorescent radiation emitted from the specimen with the fluorescent agent; and

a detection filter system which is set up to filter illumination radiation of the illumination system in the inspection system in such a way that the optical detection system detects only fluorescence radiation from the fluorescence means.

A basic idea of the disclosure and individual aspects of the subject matter are explained below and modified embodiments are described further below. Explanations, in particular regarding advantages and definitions of features, are basically descriptive, but not limiting, examples. If an explanation is limiting, this is expressly mentioned.

The present disclosure includes removing interfering radiation from the detection process. Herein lies a solution to the problem that has hitherto prevented automation. For example, the detection filter system is set up for filtering illumination radiation from the illumination system in the inspection system in such a way that the optical detection system detects only fluorescence radiation from the fluorescence agent. The optical detection system thus only detects fluorescent radiation emitted by the fluorescent agent. This method is particularly suitable for ceramic bodies, e.g., ceramic balls, as test specimens. The meaning of the formulation fluorescent agent is preferred in the scientific sense. However, the fluorescent means should be suitable as a display means in that the wavelength of the emitted fluorescent radiation deviates from the wavelength of the illuminating radiation. In this way, the detection filter system can fulfill its function and the optical detection system carry out the error check free of the skill or experience of the quality inspectors, e.g., in an automated manner.

The steps of the inspection system thus provide the following test procedure: at the beginning, an aforementioned test specimen is coated with an aforementioned fluorescent agent as a display agent. This can be done according to the state of the art. This can be done under the influence of the capillary effect. Capillarity or capillary effect is the behavior of liquids exhibited when they come into contact with capillaries, for example narrow gaps or cavities, as imperfections in solids, for example test specimens. The further fluorescent agent can, for example, be washed off or wiped off in the dye penetration method. The capillary effects are caused by the surface tension of liquids themselves and the interfacial tension between liquids and the solid surface. This means that the fluorescent agent penetrates any imperfections, i.e., cracks, crevices, or cavities.

Subsequently, the test specimen which has the fluorescent agent in any imperfections is illuminated with illuminating radiation from an illumination system having one or more illumination means. If the illuminating radiation strikes a fluorescent agent, this emits fluorescent radiation. Because of the fluorescence effect, the illumination radiation has a different wavelength than the fluorescence radiation.

Furthermore, the inspection system has an optical detection system to detect fluorescent radiation emitted by the test specimen with the fluorescent agent. To prevent false detection of supposed fluorescent radiation from being caused by the effects of the illumination radiation, a detection filter system is connected upstream of the detection system, which filters out all illumination radiation pointing to the detection system, so that the detection system only detects fluorescence radiation from genuine imperfections. This detected data can then be evaluated or utilized by a computing system for the detection of imperfections.

In this context, individual, e.g., all, steps can be carried out automatically.

In other words, it is provided that ceramic balls as test specimens are to be tested by means of an automated test with an optical inspection system, having, for example, a camera, illumination sources, and filters. This leads to an increase in output and cycle time and an increase in reproducibility.

A ceramic ball to be checked for imperfections is illuminated, for example, by means of LED UV light suitable illumination radiation of an illumination system. This contains a portion of illuminating radiation of a different wavelength which is in the range of the wavelength of the fluorescent agent emitted by excitation. This portion of the illumination radiation has a negative impact on the test and is filtered out by the detection filter system. Here, there is only the fluorescent radiation emitted by the fluorescent agent that reaches the camera as an optical detection system. There are no interfering reflections from illumination. This is important with balls and rollers. In principle, a reliable, automatable surface examination of curved test specimens is thus possible.

This is achieved, for example, by a suitable illumination filter system in front of/on/in the illumination system, which only allows the required excitation wave range for the fluorescent agent or the fluorescent radiation to pass through. This is known as spectrum filtering.

On the side of the optical detection system, i.e., on the camera side, only the wavelength of the fluorescent radiation emitted by the fluorescent agent is allowed to pass through to the optical detection system through a suitable detection filter system in the beam path in front of/on/in/behind the optical detection system, optionally in front of/on/in/behind an objective.

The fluorescent agent is therefore excited with illuminating radiation from a UV illuminator as the illuminating system. For example, green light is emitted back as fluorescent radiation.

Reflections of illumination radiation from the UV illumination may be completely filtered out, that is to say blocked, by the detection filter system in front of the detection system.

An illumination filter system may serve to further reduce the bandwidth of the illumination radiation, for example by+-10 nanometers.

Thus, either narrow-band illumination radiation from a corresponding illumination system is sufficient or broad-band illumination with an illumination filter system is used.

While a surface inspection using the dye penetration method is currently carried out manually by employees who visually inspect a few parts per hour, an automated surface inspection using the dye penetration method is possible.

For filtering or extinguishing unwanted waves, classic filters, but also means with the same effect, for example suitably coated mirrors, are used as detection filter systems or illumination filter systems. A suppression or reflection of the wavelengths to be filtered is important.

The test specimen and the fluorescent agent are only agents to be tested and are not claimed features.

According to an example embodiment, the inspection system has an illumination filter system for spectrum filtering the illumination radiation, having one or more illumination filter elements, and each illumination filter element may be arranged in the inspection system in such a way that it is arranged between a respective illumination means and the test specimen to be tested with the fluorescence means. The detection result therefore depends less on the quality of the illumination radiation emitted by the respective illumination means, but rather on the quality of the illumination radiation let through by the respective illumination filter element. This extends the flexibility in the selection of the illumination means without affecting the reliability of the surface detection.

It can optionally be provided that such high-quality illumination means are used that emit narrow-band illumination radiation.

According to an example embodiment, it is provided that the illumination filter system spectrum filters the illumination radiation in such a way that the illumination radiation, including plus/minus 10 nanometers, deviates from the specified wavelength. It has been found that illuminating radiation in this wavelength band is sufficiently narrow to ensure reliable detection.

According to an example embodiment, it is provided that the fluorescent agent and the illuminating radiation of the illumination system are selected to be interacting in such a way that the fluorescent radiation lies in a green wavelength range, e.g., between 560 and 490 nanometers inclusive. It has been found that fluorescence radiation in this wavelength range ensures reliable automated detection with a low error rate. In principle, the fluorescence radiation depends on the fluorescence agent and can deviate.

According to an example embodiment, it is provided that the illumination radiation of the illumination system is in an ultraviolet wavelength range, e.g., between 380 and 100 nanometers inclusive, between 380 and 315 nanometers inclusive, UV-B between 315 and 280 nanometers inclusive, or UV-C between 280 and 100 nanometers inclusive. It has been found that illuminating radiation in this wavelength range ensures reliable automated detection with a low error rate. For example, fluorescent means respond well to this illuminating radiation or, when this illuminating radiation is irradiated, emit a reliably detectable fluorescent radiation. The wavelength of the excitation depends on the fluorescent agent and can vary.

According to an example embodiment, it is provided that one or more illumination means of the illumination system is or are LED illumination means. LED lamps, for example, have the property that they can emit illumination radiation in different ways. Thus, the wavelength of the illuminating radiation can be adapted to the properties of the fluorescent agent, so that a reliably detectable fluorescent radiation is produced.

According to an example embodiment, it is provided that the detection system is a camera, the camera having an objective, for example, and the detection filter system being arranged in front of, on, in or behind the objective. A camera is a photographic apparatus that can electronically record static or moving images on a digital storage medium or transmit them via an interface. This is a cost-effective and reliable optical detection system for surface inspection.

According to an example embodiment, it is provided that an illumination means of the illumination system is arranged as spot illumination or that several illumination means of the illumination system are arranged as ring light or dome illumination, the illumination means in the ring light or dome illumination being evenly spaced from one another. Spot illumination means that individual illumination means are provided, with one illumination means being sufficient. This is the cheapest possible solution for flat objects. Ring light illumination is also possible. This means that illumination means are arranged on a projection ring and that the test specimen is arranged centrally to the projection ring. For example, three illumination means can be arranged on a projection ring at a uniform circular distance, in particular 120 degrees from one another. This allows good detection of imperfections on flat and curved objects. If the detection requirements are particularly high, the dome illumination is suitable, with uniform or homogeneous illumination of the test specimen so that flat, curved and even more complex objects can be tested as test specimens.

As an alternative to spots, the illumination means can also be small area lights, bar lights or similar light sources.

According to an example embodiment, it is provided that one or more illumination means of the illumination system are movably arranged in the inspection system. This allows a flexible adaptation of the detection conditions to the expected imperfection formation and geometry on the test specimen. A deviation in the test specimen geometry can also be taken into account accordingly. The arrangement of the illumination means can be carried out manually at the beginning of a detection series. Optionally, this can be done by a machine algorithm, e.g., an artificial intelligence.

It is optionally provided that one or more illumination means of the illumination system are arranged immovably in the inspection system. This prevents the illumination means from accidentally shifting or from moving further, for example due to their own weight forces, in such a way that the quality of the detection is negatively influenced.

Another option provides that at least one illumination means of the illumination system is immovable and at least one illumination means of the illumination system is movably arranged in the inspection system.

According to an example embodiment, it is provided that the inspection system has a 3D detection device to detect surface contamination on the test specimen. Due to possible surface contamination on the test specimen, for example as contamination on a spherical surface, false indications can occur due to dirt or dust. Surface contamination can basically be measured in terms of its height, i.e., radially to the test specimen. In addition to determining the imperfections by evaluating the detected fluorescence radiation, it is checked whether there is an increase at the point indicated by the fluorescent agent, i.e., a deviation from the expected area, represented for example by a change in inclination or a change in height. If this is the case, it is not a matter of an imperfection that was determined by fluorescent agents, but rather a false display due to surface contamination on the test specimen, for example due to dust/dirt. This measure can then suppress false displays and the evaluation quality can be increased. In this way, incorrect evaluations are minimized.

According to an example embodiment, it is provided that the 3D detection device designed to function of a detection principle according to shape from shading, deflectometry, stereo cameras, laser triangulation and/or strip light.

Shape from shading, also known as photometric stereo, is a technique in particular in the field of image processing to estimate the surface normals of objects by observing that object under different illumination conditions. It is based on the fact that the amount of light reflected from a surface depends on the orientation of the surface in relation to the light source and the observer. By measuring the amount of light reflected into a camera, the space of possible surface orientations is limited. With a sufficient number of light sources from different angles, the surface orientation can be restricted to a single orientation or even excessively restricted.

Deflectometry refers in particular to the contact-free acquisition or measurement of reflective surfaces. Techniques from photometry or radiometry, photogrammetry, laser scanning or laser distance measurement are used here. While diffusely reflective bodies can be recorded by analyzing the brightness distribution of reflected light sources (shape from shading), the mirror images of known patterns are analyzed in the case of flat or curved, highly reflective surfaces to determine the shape of the surface.

With the detection principle of laser triangulation, for example, angles can be measured much more easily, namely without contact, and more precisely than distances, especially if they are very long. The triangulation method is therefore used for sensitive measurements: If the angles between the sides of a triangle and the length of one of the sides of the triangle are known, the lengths of the other sides can be calculated using trigonometric formulas, for example.

In addition to laser scanning, the detection principle with strip light is a 3D scanning process that enables the user to digitize objects gently and without contact and to represent them in three dimensions. The surface information recorded is documented in the form of point clouds in the universal ASCII format. A preferred 3D light section scanner having a coded light attachment is a system with which depth resolutions and measuring accuracies of in particular approximately 0.001 mm can be achieved. To achieve this accuracy, different measurement principles and algorithms such as the triangulation method, the light section method, the coded light approach and/or the phase shift method can interlock. The scanner comprises, for example, at least one projector and at least one camera, which is optionally mounted on a tripod.

According to an example embodiment, it is provided that the test specimen and/or the 3D detection device moves or move to detect surface contamination with the 3D detection device. It has been found that this enables an increased detection speed to be achieved.

A stereo camera is a special structure for recording stereoscopic images. Stereo cameras usually have two objectives attached next to each other and, when triggered, enable the two stereoscopic (half) images required for 3D images to be recorded at the same time. The exposure control and focus adjustment of both objectives are coupled. At least two stereo cameras may be used.

The disclosure also relates to a method for surface imperfection inspections on a test specimen using an inspection system having at least one of the aforementioned features.

### BRIEF DESCRIPTION OF THE DRAWINGS

In the following, the disclosure is explained by way of example with reference to the accompanying drawings using exemplary embodiments. The features shown below can represent an aspect of the disclosure both individually and in combination. In the figures:

FIG. 1 shows a symbolic view of an inspection system according to the disclosure for optical surface inspection of a test specimen according to a first exemplary embodiment; and

FIG. 2 shows a symbolic view of an inspection system according to the disclosure for optical surface inspection of a test specimen according to a second exemplary embodiment.

FIG. 3 shows a symbolic view of an inspection system according to the disclosure for optical surface inspection of a test specimen, also with regard to surface contamination, according to a third exemplary embodiment.

### DETAILED DESCRIPTION

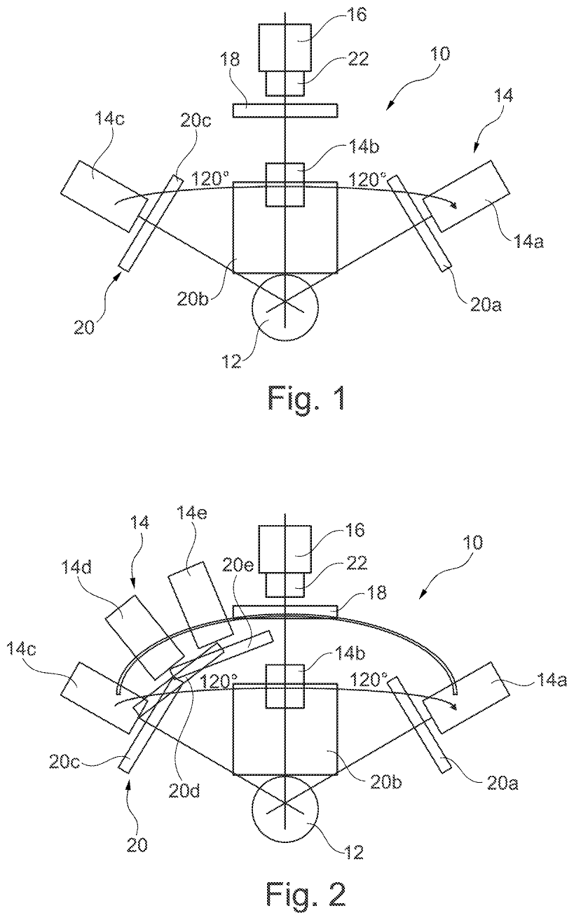

FIGS. 1 and 2 each show, in separate exemplary embodiments, an inspection system 10 for optical surface inspection of a test specimen 12 with a fluorescent agent arranged on the test specimen 12, including

an illumination system 14, for illuminating the test specimen 12 and the fluorescent means with illuminating radiation, with one or more illumination means 14a, 14b, 14c, 14d, 14e;

an optical detection system 16 for detecting fluorescent radiation emitted from the test specimen 12 with the fluorescent agent; and

a detection filter system 18 which is set up to filter illumination radiation from the illumination system 14 in the inspection system 10 such that the optical detection system 16 only detects fluorescence radiation from the fluorescence agent. The fluorescent agent is not explicitly shown, but surrounds the test specimen 12. According to the two figures, the number of illumination means is only shown as an example and is not limiting.

In both exemplary embodiments, it is provided that the inspection system 10 has an illumination filter system 20 for filtering the spectrum of the illumination radiation. According to FIG. 1, the illumination filter system 20 includes three illumination filter elements 20a, 20b, 20c, each illumination filter element 20a, 20b, 20c is arranged in the inspection system 10 such that it is between a respective illumination means 14a, 14b, 14c and the test specimen 12 to be tested with the fluorescent agent is arranged.

According to the two figures, the number of illumination filter elements is only shown as an example and is not limiting.

According to FIG. 2, the illumination filter system 20 includes five illumination filter elements 20a, 20b, 20c, 20d, 20e, each illumination filter element 20a, 20b, 20c, 20d, 20e being arranged in the inspection system 10 in such a way that it is between a respective illumination means 14a, 14b, 14c, 14d, 14e and the test specimen 12 to be tested with the fluorescent agent.

For example, it is provided for both exemplary embodiments that the illumination filter system 20 spectrum filters the illumination radiation in such a way that the illumination radiation, including plus/minus 10 nanometers, deviates from the default wavelength.

Furthermore, it is provided for both exemplary embodiments that the fluorescent agent and the illuminating radiation of the illumination system 14 are selected interactively in such a way that the fluorescent radiation lies in a green wavelength range, e.g., between 560 and 490 nanometers inclusive. The wavelength of the excitation depends on the fluorescent agent and can vary.

Furthermore, it is provided for both exemplary embodiments that the illumination radiation of the illumination system 14 is in an ultraviolet wavelength range, e.g., between 380 and 100 nanometers inclusive, UV-A between 380 and 315 nanometers inclusive, UV-B between 315 and 280 nanometers inclusive, or UV-C between 280 and 100 nanometers inclusive. The wavelength of the excitation depends on the fluorescent agent and can vary.

Furthermore, it is provided for both exemplary embodiments that one or more illumination means 14a, 14b, 14e, 14d, 14e of the illumination system 14 is or are LED illumination means.

Furthermore, it is provided for both exemplary embodiments that the detection system 16 is a camera, the camera having an objective 22, the detection filter system 18 being arranged in front of the objective 22.

According to FIG. 1 it is provided that three illumination means 14a, 14b, 14c of the illumination system 14 are arranged as spot illumination in such a way that they are arranged as ring light illumination, with the illumination means 14a, 14b, 14c being evenly spaced from one another in the ring light illumination are. The beam paths are shown symbolically with lines. Measured on the ring, the illumination means 14a, 14b, 14c are arranged one after the other at a distance of 120 degrees from one another.

According to FIG. 2 it is provided that the illumination means 14a, 14b, 14c, 14d, 14e of the illumination system 14 are arranged as spot illumination in such a way that they are arranged as dome illumination, with the illumination means 14a, 14b, 14c, 14d, 14e are evenly spaced from one another in the dome illumination. This is only shown symbolically. Some beam paths are shown symbolically with lines.

Basically, you get ring illumination if you increase the number of exemplary LED spots and their filters and arrange them on a circular band at equidistant intervals. If the number of equidistant rings is also extended upwards to a hemisphere, a dome illumination is obtained.

Optionally and independently of the exemplary embodiments, it is possible to use a semitransparent mirror in the upper area, in a complementary fashion or alone.

For example, it is provided that one or more illumination means 14a, 14b, 14c, 14d, 14e of the illumination system 14 are movably arranged in the inspection system 10.

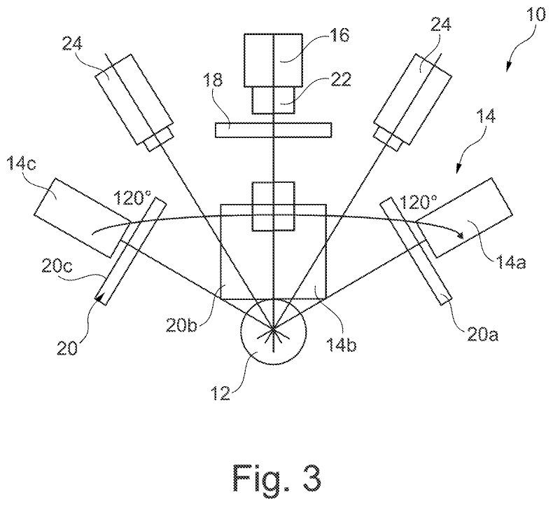

According to FIG. 3, it is provided that the inspection system 10, in addition to the inspection system 10 according to FIG. 1, has a 3D detection device 24 to detect surface contamination on the test specimen 12. It is shown as an example that the 3D detection device 24 has a stereo camera structure. It is also possible for the 3D detection device 24 to use further detection principles. According to FIG. 3, it is possible for the test specimen 12 and/or the 3D detection device 24 to move or move to detect surface contamination with the 3D detection device 24.

### REFERENCE NUMERALS

10 inspection system

12 Test specimens (with fluorescent agent)

14 Illumination system

14a First illumination means of the illumination system

14b Second illumination means of the illumination system

14c Third illumination means of the illumination system

14d Fourth illumination means of the illumination system

14e Fifth illumination means of the illumination system

16 Detection system

18 Detection filter system

20 Illumination Filter System

20a First illumination filter element of the illumination filter system

20b Second illumination filter element of the illumination filter system

20c Third illumination filter element of the illumination filter system

20d Fourth illumination filter element of the illumination filter system

20e Fifth illumination filter element of the illumination filter system

22 Objective

24 3D detection device

1. An inspection system for optical surface inspection of a test specimen having a fluorescent agent arranged on the test specimen, comprising
an illumination system for illuminating the test specimen and the fluorescent agent with illuminating radiation, with one or more illuminating mean;
an optical detection system for detecting fluorescent radiation emitted by the test specimen with the fluorescent agent;
a detection filter system which is set up to filter illumination radiation of the illumination system in the inspection system in such a way that the optical detection system only detects fluorescence radiation from the fluorescence agent.

2. The inspection system for optical surface inspection of a test specimen having a fluorescent agent arranged on the test specimen according to claim 1, wherein
the inspection system has an illumination filter system for spectrum filtering the illumination radiation, with one or more illumination filter elements, and
each illumination filter element is arranged in the inspection system in such a way that it is arranged between a respective illumination means and the test specimen to be tested with the fluorescent agent.

3. The inspection system for optical surface inspection of a test specimen having a fluorescent agent arranged on the test specimen according to claim 2, wherein
the illumination filter system spectrum filters the illumination radiation in such a way that the illumination radiation, including plus/minus 10 nanometers, deviates from the specified wavelength.

4. The inspection system for optical surface inspection of a test specimen having a fluorescent agent arranged on the test specimen, according to at claim 1, wherein
the fluorescent agent and the illuminating radiation of the illumination system are selected interactively in such a way that the fluorescent radiation lies in a green wavelength range between 560 and 490 nanometers inclusive.

5. The inspection system for optical surface inspection of a test specimen having a fluorescent agent arranged on the test specimen, according to claim 1, wherein
the illumination radiation of the illumination system is in an ultraviolet wavelength range, between 380 and 100 nanometers inclusive, UV-A between 380 and 315 nanometers inclusive, UV-B between 315 and 280 nanometers inclusive or UV-C between 280 and 100 nanometers inclusive.

6. The inspection system for optical surface inspection of a test specimen having a fluorescent agent arranged on the test specimen, according to claim 1, wherein
one or more illumination means of the illumination system is or are LED illumination means.

7. The inspection system for optical surface inspection of a test specimen having a fluorescent agent arranged on the test specimen, according to claim 6, wherein
the detection system is a camera,
the camera having an objective, and
the detection filter system being arranged in front of, on, in or behind the objective.

8. The inspection system for optical surface inspection of a test specimen having a fluorescent agent arranged on the test specimen, according to claim 7, wherein
an illumination means of the illumination system is arranged as spot illumination, or
several illumination means of the illumination system are arranged as a ring light or dome illumination, the illumination means in the ring light or dome illumination being evenly spaced from one another.

9. The inspection system for optical surface inspection of a test specimen having a fluorescent agent arranged on the test specimen, according to claim 8, wherein
one or more illumination means of the illumination system are movably arranged in the inspection system.

10. The inspection system for optical surface inspection of a test specimen having a fluorescent agent arranged on the test specimen, according to
the inspection system has a 3D detection device to detect surface contamination on the test specimen.

11. The inspection system for optical surface inspection of a test specimen having a fluorescent agent arranged on the test specimen, according to claim 10, wherein
the 3D detection device is designed for the function of a detection principle according to shape from shading, deflectometry, stereo cameras, laser triangulation or strip light.

12. The inspection system for optical surface inspection of a test specimen having a fluorescent agent arranged on the test specimen, according to claim 10, wherein
the test specimen or the 3D detection device is movable to detect surface contamination by means of the 3D detection device.

13. (canceled)

14. An inspection system for optical surface inspection of a test specimen having a fluorescent agent arranged thereon, comprising:
an illumination system comprising an illuminating means for illuminating the test specimen with an illumination radiation;
an optical detection system for detecting a fluorescent radiation emitted by the test specimen; and
a detection filter system arranged to filter the illumination radiation such that the optical detection system only detects the fluorescent radiation.

15. The inspection system of claim 14, further comprising an illumination filter system for spectrum filtering the illumination radiation, the illumination filter system comprising a filter element.

16. The inspection system of claim 15 wherein the filter element is arranged between the illuminating means and the test specimen.

17. The inspection system of claim 15, wherein the illumination filter system spectrum filters the illumination radiation that deviates from a specified wavelength by more than 10 nanometers

18. The inspection system of claim 14 wherein the fluorescent agent and the illuminating radiation are selected interactively so that the fluorescent radiation lies in a green wavelength range

19. The inspection system of claim 18 wherein the green wavelength range is between 560 and 490 nanometers inclusive.

20. The inspection system of claim 14 wherein the illumination radiation is in an ultraviolet wavelength range between 380 and 100 nanometers inclusive.
